(19) United States
(12) Patent Application Publication
(10) Pub. No.: US 2022/0159778 A1
(43) Pub. Date: May 19, 2022

(54) SYSTEM AND METHOD THEREFOR

(71) Applicant: NEC Corporation, Minato-ku, Tokyo (JP)

(72) Inventor: Hiroaki AMINAKA, Tokyo (JP)

(73) Assignee: NEC Corporation, Minato-ku, Tokyo (JP)

(21) Appl. No.: 17/439,499

(22) PCT Filed: Dec. 6, 2019
(86) PCT No.: PCT/JP2019/047731

§ 371 Date: Sep. 15, 2021

(30) Foreign Application Priority Data
Mar. 22, 2019 (JP) 2019-055093

(51) Int. Cl. H04W 76/45; H04W 4/10; H04W 76/12; H04W 76/50; H04W 8/18; H04W 76/14; H04W 76/15; H04W 72/10

(52) U.S. Cl. CPC H04W 76/45; H04W 4/10; H04W 76/12; H04W 76/50; H04W 88/18; H04W 76/14; H04W 76/15; H04W 72/10; H04W 8/18

(57) ABSTRACT

At least one server (11) receives from a first wireless terminal (2A) a request for a communication session between the first wireless terminal (2A) and a second wireless terminal (2B). The at least one server (11) determines, based on one or both of first and second priorities associated respectively with the first and second wireless terminals. Furthermore, the at least one server (11) requests a cellular communication network (3) to establish two communication paths (412, 413), respectively for the first and second wireless terminals (2A, 2B), that both satisfy the common priority. This, for example, makes it possible to adjust priorities of a plurality of bearers, which are configured for a plurality of devices in a cellular communication network for a group communication session between these devices though the cellular communication network.

### TECHNICAL FIELD

The present disclosure relates to wireless communication and, in particular, to provision of a communication session between a plurality of wireless terminals via a cellular communication network.

### BACKGROUND ART

It is being considered to use a Long Term Evolution (LTE) network for a public safety network. The public safety network is a wireless communication network used for emergency services such as police, firefighting, and medical emergency, as well as highly public applications such as local governments and electric power, gas, and water utilities. The LTE system for public safety networks is called Public Safety LTE (PS-LTE). The Third Generation Partnership Project (3GPP) defines Mission Critical Push-to-Talk (MCPTT), which is one of the main features of PS-LTE (see, for example, Non-Patent Literature 1). The MCPTT architecture uses the aspects of the Group Communication System for LTE (GCSE_LTE) architecture, and also the aspects of the IP Multimedia Subsystem (IMS) architecture and the Proximity-based Services (ProSe) architecture. The GCSE_LTE enables group communication (see, for example, Non-Patent Literature 2).

It can be said that the PS-LTE network or system is a collection of hardware entities that provide applications, services, capabilities, and functions required to provide public safety services on an LTE network. The PS-LTE network or system may be a public LTE network (Public Land Mobile Network (PLMN)), a private LTE network, or a combination thereof.

The PS-LTE provides public safety services such as a PTT service. The PTT service is a Push To Talk communication service supporting applications for Mission Critical Organizations and for other businesses and organizations (e.g., public utilities and railways) with fast setup times, high availability, and reliability and priority handling. The public safety organizations include, for example, local police departments and local fire departments.

A user (e.g., PTT user) who uses a public safety service (e.g., PTT service) uses a wireless terminal or device (e.g., PS User Equipment (UE)) which has the capability to participate in the public safety service. Such devices (e.g., PS UE) allow users to participate in public safety services. Public safety service users include, for example, police officers and firefighters.

A public safety service provider is authorized to control parameters of the public safety service (e.g., PTT service) provided to a public safety organization. These parameters include, for example, user and group definition, user priorities, group membership/priorities/hierarchies, and security and privacy controls. A public safety service provider can also be referred to as a public safety service administrator.

The business relationships of public safety service users, public safety organizations, and public safety service providers are as follows. A public safety service user belongs to a single public safety organization based on a user agreement. The public safety organization receives a public safety service from a public safety service provider based on an agreement. The public safety service user can have a user contract and service arrangement direct with the public safety service provider. The public safety organization and the public safety service provider can be part of the same organization. Further or alternatively, the public safety service provider and the PS-LTE network operator can be part of the same organization.

### CITATION LIST

### Non-Patent Literature

[Non-Patent Literature 1] 3GPP TS 23.179 V13.5.0 (2017-03), “3rd Generation Partnership Project; Technical Specification Group Services and System Aspects; Functional architecture and information flows to support mission critical communication services; Stage 2 (Release 13)”, March 2017
[Non-Patent Literature 2] 3GPP TS 23.468 V15.0.0 (2017-12), “3rd Generation Partnership Project; Technical Specification Group Services and System Aspects; Group Communication System Enablers for LTE (GCSE_LTE); Stage 2 (Release 15)”, December 2017

### SUMMARY OF INVENTION

### Technical Problem

A PS-LTE network or system that provides a public safety service requires priority handling at various levels regarding business relationships. Specifically, for example, priority handling between multiple public safety organizations, between multiple public safety service users (or devices (UEs)), and between multiple public safety service applications are needed. The multiple public safety service applications include, for example, a PTT application, a push-to-video application, a voice call application, a video call application, and an instant messaging application.

A PS-LTE network or system provides a group communication session (e.g., a communication session for PTT, push-to-video, voice call, or instant messaging) between devices (UEs) through an LTE network. Such a group communication session utilizes bearers (i.e., Evolved Packet System (EPS) bearers) configured for the respective devices (UEs) in the LTE network. In this case, for example, if multiple users or devices involved in a group communication session have different priorities from each other, the priorities of the EPS bearers for these devices may also differ from each other. The priority of an EPS bearer includes, for example, a Quality of Service (QoS) Class Identifier (QCI), an Allocation and Retention Priority (ARP), or both. This may cause end-to-end communication between the devices not to get the desired priority.

One of the objects to be attained by embodiments disclosed herein is to provide apparatuses, methods, and programs that enable adjustment of priorities of a plurality of bearers, which are configured for a plurality of devices in a cellular communication network for a group communication session between these devices though the cellular communication network. It should be noted that this object is merely one of the objects to be attained by the embodiments disclosed herein. Other objects or problems and novel features will be made apparent from the following description and the accompanying drawings.

### Solution to Problem

In a first aspect, a system includes at least one server. The at least one server is configured to receive from an application running on a first wireless terminal, via a first communication path provided by a cellular communication network, a request for a communication session between the first wireless terminal and a second wireless terminal. The at least one server is configured to determine, based on one or both of a first priority associated with the first wireless terminal and a second priority associated with the second wireless terminal, a common priority to be applied to both a second communication path of the first wireless terminal and a third communication path of the second wireless terminal used for the communication session. In addition, the at least one server is configured to request the cellular communication network to establish the second and third communication paths that satisfy the common priority. Furthermore, the at least one server is configured to provide the communication session to the first and second wireless terminals via the second and third communication paths.

In a second aspect, a method performed by a system including at least one server includes:
(a) receiving from an application running on a first wireless terminal, via a first communication path provided by a cellular communication network, a request for a communication session between the first wireless terminal and a second wireless terminal;
(b) determining, based on one or both of a first priority associated with the first wireless terminal and a second priority associated with the second wireless terminal, a common priority to be applied to both a second communication path of the first wireless terminal and a third communication path of the second wireless terminal used for the communication session;
(c) requesting the cellular communication network to establish the second and third communication paths that satisfy the common priority; and
(d) providing the communication session to the first and second wireless terminals via the second and third communication paths.

In a third aspect, a program includes instructions (software codes) that, when loaded into a computer, cause the computer to perform the method according to the above-described second aspect.

### Advantageous Effects of Invention

According to the above-described aspects, it is possible to provide apparatuses, methods, and programs that enable adjustment of priorities of a plurality of bearers, which are configured for a plurality of devices in a cellular communication network for a group communication session between these devices though the cellular communication network.

### BRIEF DESCRIPTION OF DRAWINGS

FIG. 1 is a block diagram showing a configuration example of a cellular communication network according to embodiments;

FIG. 2 is a block diagram showing a configuration example of a network platform according to embodiments;

FIG. 3 is a flowchart showing an example of operation of a network platform according to a first embodiment;

FIG. 4 is a sequence diagram showing an example of a procedure for establishing a group communication session according to the first embodiment;

FIG. 5 is a sequence diagram showing an example of operation of a network platform according to a second embodiment;

FIG. 6 is a sequence diagram showing an example of operation of a network platform according to a third embodiment;

FIG. 7 is a block diagram showing a configuration example of a server according to embodiments; and

FIG. 8 is a block diagram showing a configuration example of a wireless terminal according to embodiments.

### DESCRIPTION OF EMBODIMENTS

Specific embodiments will be described hereinafter in detail with reference to the drawings. The same or corresponding elements are denoted by the same symbols throughout the drawings, and duplicated explanations are omitted as necessary for the sake of clarity.

### First Embodiment

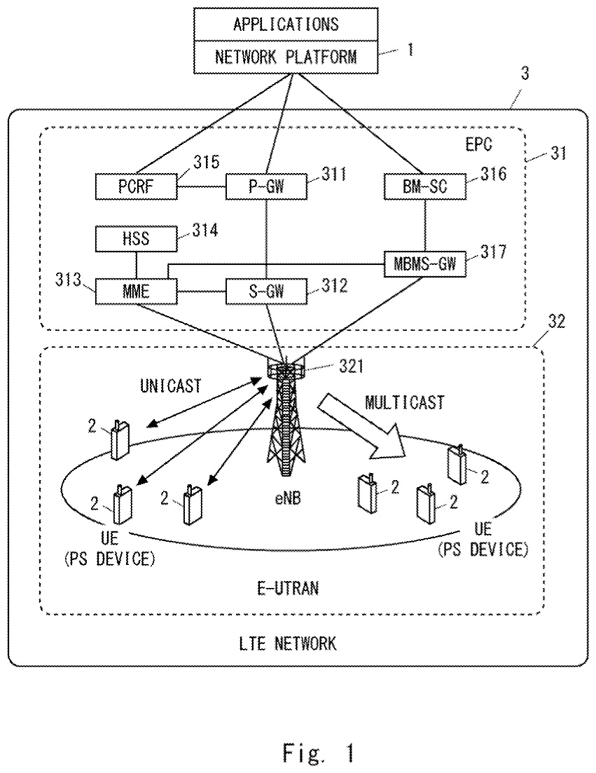

FIG. 1 shows a configuration example of a PS-LTE network or system according to embodiments including the present embodiment. The PS-LTE network or system provides one or more public safety services (e.g., a PTT service). In the example of FIG. 1, the PS-LTE network includes a network platform 1 and an LTE network 3. The network platform 1 communicates with one or more applications (e.g., a PTT client application and a Session Initiation Protocol (SIP) client application) running on each of a plurality of wireless terminals (UEs) 2 through one or more communication paths provided by the LTE network 3. In other words, the network platform 1 includes a plurality of functional entities in the application domain and communicates with the UEs 2 on the application layer (or application service layer). The UEs 2 are also referred to as public safety devices.

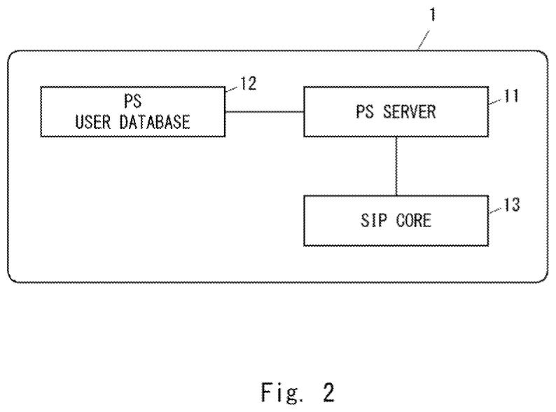

The network platform 1 includes one or more servers. Each server included in the network platform 1 may be one or more computers. For example, as shown in FIG. 2, the network platform 1 may include a PS server 11, a PS user database 12, and a SIP core 13. The PS server 11 provides centralized support for a PS service (e.g., PTT service, push-to-video service). More specifically, the PS server 11 is responsible for, for example, PS user authentication, keeping tracking of the locations of the UEs 2 (PS UEs), and requesting the allocation of resources in the cellular communication network to the UEs 2. The PS server 11 may include the functions of a GCS application server (AS). The PS user database 12 stores information of PS user profiles. The PS user profile are determined by a public safety organization, a public safety service provider, and potentially a public safety service user. The SIP core 13 is in charge of SIP registration, establishes a SIP signaling bearer, and sends and receives SIP signaling messages to and from each UE 2 (SIP client on each UE 2). The PS user database 12 may be a device outside the network platform 1.

Further or alternatively, the network platform 1 may include other servers. The network platform 1 may include, for example, but not limited to, a GCS application server (AS) and/or a SIP database. The GCS AS uses an EPS bearer service or an MBMS bearer service, performing transfer or delivery of application signaling and application data to a group of UEs. The SIP database stores SIP subscriber information (SIP subscriptions) and authentication information that are required by the SIP core 13.

The LTE network 3 includes a core network (i.e., Evolved Packet Core (EPC)) 31 and a radio access network (i.e., Evolved Universal Terrestrial Radio Access Network (E-UTRAN)) 32. The EPC 31 includes a plurality of nodes, which include a plurality of control plane nodes and a plurality of user plane (or data plane) nodes. One or more nodes in the EPC 31 may have both control plane and user plane functions. For example, as shown in FIG. 1, the EPC 31 may include a Packet Data Network Gateway (P-GW) 311, a Serving Gateway (S-GW) 312, a Mobility Management Entity 313, a Home Subscriber Server (HSS) 314, a Policy and Charging Rules Function (PCRF) 315, a Broadcast Multicast Service Center (BM-SC) 316, and an MBMS Gateway (MBMS GW) 317. The E-UTRAN 32 includes a base station (eNodeB (eNB)) 321. Of course, although not explicitly shown in FIG. 1, the EPC 31 may include a plurality of S-GWs 312, and the E-UTRAN 32 may include a plurality of eNBs 321.

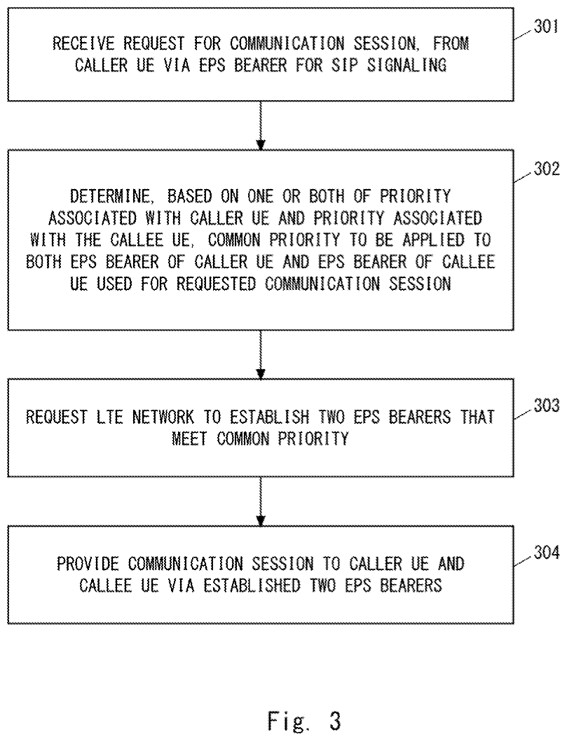

FIG. 3 shows an example of an operation of the network platform 1 according to the present embodiment. The operation shown in FIG. 3 may be performed by a single server (e.g., the PS server 11) in the network platform 1 or by a plurality of servers (e.g., the PS server 11 and the PS user database 12).

In step 301, the network platform 1 receives a request for a communication session, from an application running on the caller UE 2A via an EPS bearer for SIP signaling. The application running on UE 2A may be, for example, a PTT application client or a SIP application client. The communication session is a group communication session between the caller UE 2A and the callee UE 2B. The communication session may be, for example, a communication session for PTT, push-to-video, voice call, or instant messaging. The EPS bearer for SIP signaling may be a default bearer configured by the LTE network 3 for the UE 2A.

In step 302, the network platform 1 acquires one or both of a priority associated with the caller UE 2A and a priority associated with the callee UE 2B. Each of the priorities of the UE 2A and the UE 2B may be one or any combination of organization priority, device priority, and application priority.

The organization priority is a priority (or priority level) of each of a plurality of public safety organizations (e.g., local police departments and multiple local fire departments) that use a public safety service provided by the PS-LTE network. The organization priority is used for priority handling among these multiple public safety organizations.

The device priority is a priority (or priority level) of each UE 2 used by each user belonging to a single public safety organization. The device priority is used for priority handling among multiple UEs 2.

The application priority is a priority (or priority level) of each public safety service application executed on each UE 2 (or of each application service provided to each UE 2). The application priority is used for priority handling among multiple applications. The multiple public safety service applications include, for example, any combination of a PTT application, a push-to-video application, a voice call application, a video call application, and an instant messaging application.

The network platform 1 determines, based on one or both of the priority associated with the caller UE 2A and the priority associated with the callee UE 2B, a common priority to be applied to both an EPS bearer of the caller UE 2A and an EPS bearer of the callee UE 2B used for the requested communication session. These EPS bearers are set up in the LTE network 3 respectively for the caller UE 2A and the callee UE 2B for the group communication session between the caller UE 2A and the callee UE 2B. These EPS bearers may be dedicated bearers configured in addition to the default bearers of the caller UE2 A and the callee UE 2B.

In some implementations, the network platform 1 may obtain the organization priority, device priority, and application priority from a server that manages information on public safety service users. The server may be, for example, the PS user database 12, the HSS 314, a SIP database (not illustrated), or a Subscription Profile Repository (SPR) (not illustrated).

The common priority may indicate an application layer priority (e.g., organization priority, device priority, or application priority). In this case, the network platform 1 may convert the common priority to an EPS bearer priority (e.g., QCI value, ARP value, or both), or a control node (e.g., PCRF 315) in the EPC 31 may convert the common priority to the EPS bearer priority. Alternatively, the common priority may indicate an EPS bearer priority.

In some implementations, the network platform 1 may determine the common priority according to the higher one of the priority associated with the caller UE 2A and the priority associated with the callee UE 2B. More specifically, the network platform 1 may set the common priority equally to the higher one of the priority associated with the caller UE 2A and the priority associated with the callee UE 2B.

Alternatively, the network platform 1 may determine the common priority according to the priority associated with the caller UE 2A. More specifically, the network platform 1 may set the common priority equal to the priority associated with the caller UE 2A.

Instead, the network platform 1 may determine the common priority according to the priority associated with callee UE 2B. More specifically, the network platform 1 may set the common priority equal to the priority associated with callee UE 2B.

In step 303, the network platform 1 requests the LTE network 3 to establish two EPS bearers that meet the determined common priority. If dedicated bearers for the group communication have already been established, the request in step 303 may be a request for modification of the already established dedicated bearers. The network platform 1 may send the request of step 303 to a control node (e.g., PCRF 315) in the EPC 31.

In step 304, the network platform 1 provides the group communication session to the UE 2A and the UE 2B via the two EPS bearers established (or modified) by the LTE network 3.

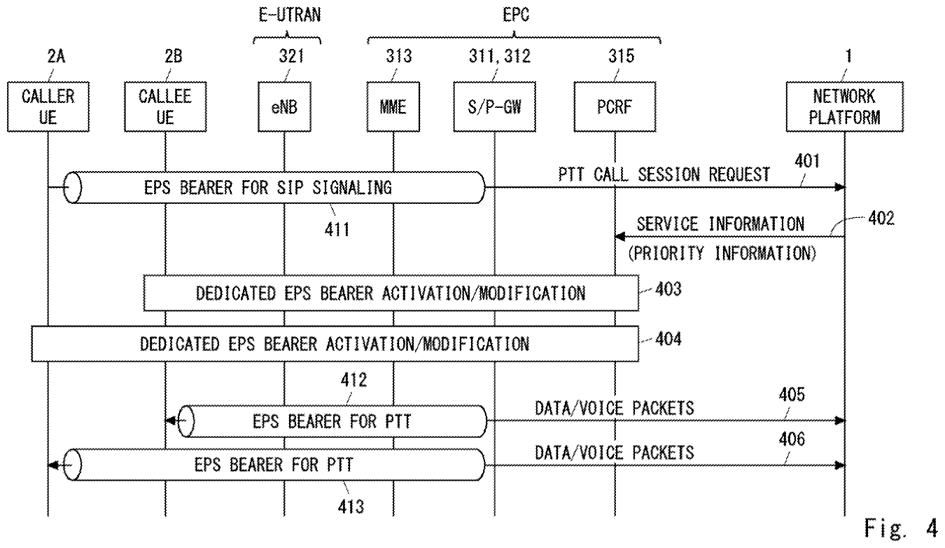

FIG. 4 is a sequence diagram showing an example of the procedure for establishing a group communication session according to the present embodiment. In step 401, an application running on the caller UE 2A sends to the network platform 1, via an EPS bearer 411 for SIP signaling, a request for a group communication session between the caller UE 2A and the callee UE 2B (e.g., PTT CALL SESSION REQUEST).

In response to the request, the network platform 1 acquires one or both of a priority associated with the caller UE 2A and a priority associated with the callee UE 2B. The network platform 1 then determines a common priority to be applied to both an EPS bearer 412 of the caller UE 2A and an EPS bearer 413 of the callee UE 2B used for the requested communication session.

In step 402, the network platform 1 sends a signaling message including service information to the PCRF 315 in the EPC 31. The service information indicates the common priority and triggers the PCRF 315 to establish (or modify) the two EPS bearers 412 and 413 based on the common priority. The network platform 1 may send the PCRF 315 two signaling messages for establishing (or modifying) the EPS bearers 412 and 413, respectively.

As described above, the common priority may indicate an application layer priority (e.g., organization priority, device priority, or application priority). In this case, the network platform 1 may convert the common priority to an EPS bearer priority (e.g., QCI value, ARP value, or both), or the control node (e.g., PCRF 315) in the EPC 31 may convert the common priority to the EPS bearer priority. Alternatively, the common priority may indicate an EPS bearer priority.

In step 403, in response to the trigger from the network platform 1, the PCRF 315 performs a procedure for establishing or modifying the EPS bearer (or dedicated bearer) 412 for the caller UE 2A. Specifically, the PCRF 315 requests the P-GW 311 (i.e., policy and charging enforcement function (PCEF)) to establish the EPS bearer 412 that satisfies the common priority (or a common EPS bearer priority associated with the common priority). In response to a request from the PCRF 315, the P-GW 311 requests the S-GW 312 to create (or modify) a dedicated bearer and initiates the procedure for creating (or modifying) the dedicated EPS bearer 412. As a result, the dedicated EPS bearer 412 associated with the common priority is established between the P-GW311 and the UE 2A through the S-GW 312 and the eNB 321.

In step 404, like the EPS bearer (or dedicated bearer) 412, the dedicated EPS bearer 413 associated with the common priority is established between the P-GW 311 and the UE 2A through the S-GW 312 and the eNB 321. The S-GW 312 and the eNB 321 through which the EPS bearer 413 passes may be different from those through which the EPS bearer 412 passes.

In steps 405 and 406, the network platform 1 provides the group communication session to the UEs 2A and 2B via the dedicated EPS bearers 412 and 413 associated with the common priority.

The above-described operations allow the network platform 1 to enforce the common priority on a plurality of bearers configured for a plurality of devices in the LTE network 3 to perform a group communication session between the UEs 2A and 2B. Therefore, the end-to-end communication between the UEs 2A and 2B can obtain the desired (common) priority.

### Second Embodiment

The present embodiment provides a specific example of the operation of the network platform 1 described in the first embodiment. A configuration example of a PS-LTE network according to the present embodiment is the same as that shown in FIGS. 1 and 2.

In the present embodiment, the PS server 11 acquires one or both of two priorities associated respectively with the caller UE2 A and the callee UE 2B, determines a common priority, and send service information to the LTE network 3 (PCRF 315) to trigger the creation of two EPS bearers associated with the common priority and for the UE 2A and the UE 2B.

In one example, the PS server 11 may acquire one or both of the two priorities associated with the caller UE 2A and the callee UE 2B from the PS user database 12. Alternatively, the PS server 11 may obtain one or both of these two priorities from the SIP core 13, the HSS 314, a SIP database (not illustrated), or an SPR (not illustrated).

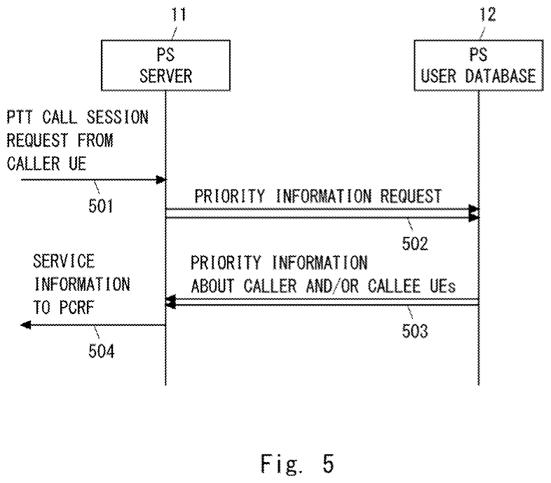

FIG. 5 shows an example of an operation of the network platform 1 according to the present embodiment. In step 501, the PS server 11 receives a request for a group communication session between the caller UE 2A and the callee UE 2B (e.g., PTT CALL SESSION REQUEST) from the caller UE 2A. In step 502, the PS server 11 sends a request for priority information to the PS user database 12. The request relates to one or both of the two priorities associated respectively with the caller UE 2A and the callee UE 2B. In step 503, the PS user database 12 sends a response indicating one or both of the two priorities to the PS server 11. In step 504, the PS server 11 determines a common priority and sends service information to the LTE network 3 (PCRF 315) to trigger the creation of two EPS bearers associated with the common priority and for the UE 2A and UE 2B.

The above-described operations allow the PS server 11 to cooperate with the PS user database 12 (or another server or database) and enforce the common priority on a plurality of bearers configured for a plurality of devices in the LTE network 3 to perform a group communication session between the UEs 2A and 2B.

### Third Embodiment

The present embodiment provides a specific example of the operation of the network platform 1 described in the first embodiment. A configuration example of a PS-LTE network according to the present embodiment is the same as that shown in FIGS. 1 and 2.

In this embodiment, the PS server 11 or the SIP core 13 acquires one or both of two priorities associated respectively with the caller UE 2A and the callee UE 2B, determines the common priority, and sends service information to the LTE network 3 (PCRF 315) to trigger the creation of two EPS bearers associated with the common priority and for the UE 2A and UE 2B.

In one example, the SIP core 13 may acquire one or both of the two priorities associated respectively with caller UE 2A and the callee UE 2B from a SIP database. Alternatively, the PS server 11 may obtain one or both of these two priorities from the HSS 314 or an SPR (not illustrated).

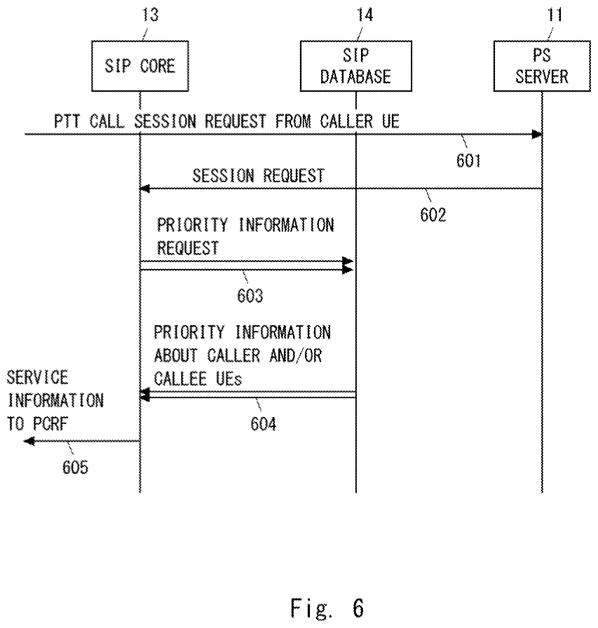

FIG. 6 shows an example of an operation of the network platform 1 according to the present embodiment. In step 601, the PS server 11 receives a request for a group communication session between the caller UE 2A and the callee UE 2B (e.g., PTT CALL SESSION REQUEST) from the caller UE 2A. In step 602, the request for the communication session is sent to the SIP core 13. In step 603, the SIP core 13 sends a request for priority information to the SIP database 14. This request relates to one or both of two priorities associated respectively with the caller UE 2A and the callee UE 2B. In step 604, the SIP database 14 sends a response indicating one or both of the two priorities to the SIP core 13. In step 605, the SIP core 13 determines a common priority and sends service information to the LTE network 3 (PCRF 315) to trigger the creation of two EPS bearers associated with the common priority and for the UE 2A and UE 2B.

The above-described operations allow the SIP core 13 to cooperate with the SIP database 14 (or another server or database) and enforce the common priority on a plurality of bearers configured for a plurality of devices in the LTE network 3 to perform a group communication session between the UEs 2A and 2B.

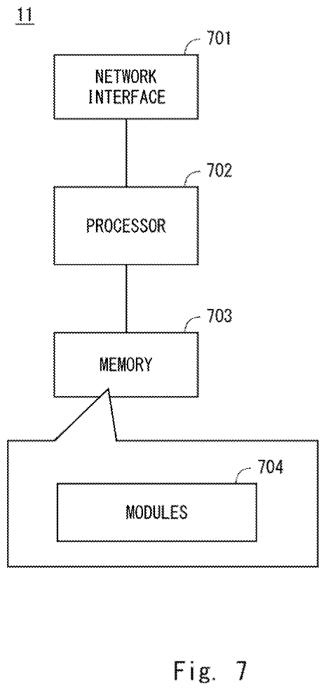

The following provides configuration examples of the one or more servers in the network platform 1, and the UE 2 according to the above-described embodiments. FIG. 7 is a block diagram showing a configuration example of the PS server 11. The configurations of the other servers in the network platform 1 may be similar to that shown in FIG. 7. Referring to FIG. 7, the PS server 11 includes a network interface 701, a processor 702, and a memory 703. The network interface 701 is used to communicate with other servers (e.g., PS user database 12 and the SIP core 13) in the network platform 1, nodes (e.g., the P-GW 311, the PCRF 315, and the BM-SC 316) in the EPC 31, and other nodes. The network interface 701 may include, for example, a network interface card (NIC) conforming to the IEEE 802.3 series.

The processor 702 loads and executes software (computer programs) from the memory 703, thereby performing the processing of the PS server 11 described in the above embodiments. The processor 702 may be, for example, a microprocessor, a Micro Processing Unit (MPU), or a Central Processing Unit (CPU). The processor 702 may include a plurality of processors.

The memory 703 is composed of a volatile memory and a nonvolatile memory. The volatile memory is, for example, a Static Random-Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 703 may include a storage located apart from the processor 702. In this case, the processor 702 may access the memory 703 via the network interface 701 or an I/O interface (not illustrated).

The memory 703 may store one or more software modules (computer programs) 704 including instructions and data to perform the processing of the PS server 11 described in the above embodiments. In some implementations, the processor 702 may be configured to load the one or more software modules 704 from the memory 703 and execute the loaded software modules, thereby performing the processing of the PS server 11 described in the above embodiments.

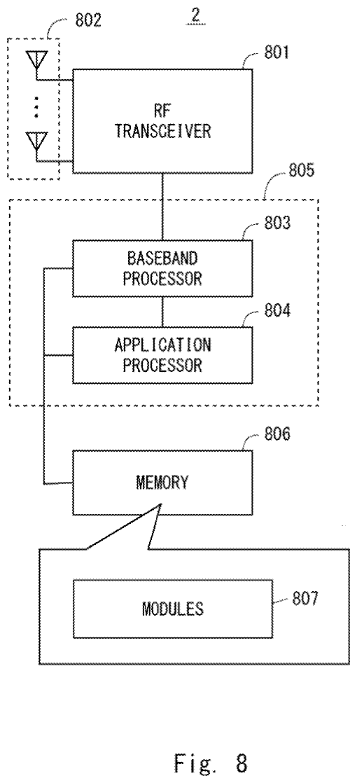

FIG. 8 is a block diagram showing a configuration example of the UE 2. A Radio Frequency (RF) transceiver 801 performs analog RF signal processing to communicate with the gNB 321. The RF transceiver 801 may include a plurality of transceivers. The analog RF signal processing performed by the RF transceiver 801 includes frequency up-conversion, frequency down-conversion, and amplification. The RF transceiver 801 is coupled to an antenna array 802 and a baseband processor 803. The RF transceiver 801 receives modulated symbol data (or OFDM symbol data) from the baseband processor 803, generates a transmission RF signal, and supplies the transmission RF signal to the antenna array 802. The RF transceiver 801 also generates a baseband received signal based on a received RF signal received by the antenna array 802 and supplies the baseband received signal to the baseband processor 803. The RF transceiver 801 may include an analog beamformer circuit for beam forming. The analog beamformer circuit includes, for example, a plurality of phase shifters and a plurality of power amplifiers.

The baseband processor 803 performs digital baseband signal processing (i.e., data-plane processing) and control-plane processing for radio communication. The digital baseband signal processing includes, for example, (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 803 may include, for example, signal processing of a Packet Data Convergence Protocol (PDCP) layer, a Radio Link Control (RLC) layer, a Medium Access Control (MAC) layer, and a Physical (PHY) layer. The control-plane processing performed by the baseband processor 803 may include processing of Non-Access Stratum (NAS) protocols, Radio Resource Control (RRC) protocols, and MAC Control Elements (CEs).

The baseband processor 803 may perform MIMO encoding and pre-coding for beam forming.

The baseband processor 803 may include a modem processor (e.g., Digital Signal Processor (DSP)) that performs the digital baseband signal processing and a protocol stack processor (e.g., a CPU or an MPU) that performs the control-plane processing. In this case, the protocol stack processor, which performs the control-plane processing, may be integrated with an application processor 804 described in the following.

The application processor 804 is also referred to as a CPU, an MPU, a microprocessor, or a processor core. The application processor 804 may include a plurality of processors (processor cores). The application processor 804 loads a system software program (Operating System (OS)) and various application programs (e.g., a call application, a WEB browser, a mailer, a camera operation application, and a music player application) from a memory 806 or from another memory (not illustrated) and executes these programs, thereby providing various functions of the UE 2.

In some implementations, as represented by a dashed line (805) in FIG. 8, the baseband processor 803 and the application processor 804 may be integrated on a single chip. In other words, the baseband processor 803 and the application processor 804 may be implemented in a single System on Chip (SoC) device 805. An SoC device may be referred to as a Large-Scale Integration (LSI) or a chipset.

The memory 806 is a volatile memory, a non-volatile memory, or a combination thereof. The memory 806 may include a plurality of memory devices that are physically independent from each other. The volatile memory is, for example, an SRAM, a DRAM, or a combination thereof. The non-volatile memory is, for example, an MROM, an EEPROM, a flash memory, a hard disc drive, or any combination thereof. The memory 806 may include, for example, an external memory device that can be accessed from the baseband processor 803, the application processor 804, and the SoC 805. The memory 806 may include an internal memory device that is integrated in the baseband processor 803, the application processor 804, or the SoC 805. The memory 806 may also include a memory in a Universal Integrated Circuit Card (UICC).

The memory 806 may store one or more software modules (computer programs) 807 including instructions and data to perform the processing by the UE 2 described in the above embodiments. In some implementations, the baseband processor 803 or the application processor 804 may load these software modules 807 from the memory 806 and execute the loaded software modules, thereby performing the processing of the UE 2 described in the above embodiments with reference to the drawings.

The control-plane processing and operations performed by the UE 2 described in the above embodiments can be achieved by elements other than the RF transceiver 801 and the antenna array 802, i.e., achieved by the memory 806, which stores the software modules 807, and one or both of the baseband processor 803 and the application processor 804.

As described above with reference to FIGS. 7 and 8, each of the processors that the server (e.g., the PS server 11) and the UE 2 according to the above embodiments include executes one or more programs including instructions for causing a computer to execute an algorithm described with reference to the drawings. These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

### Other Embodiments

Each of the above-described embodiments may be used individually or two or more embodiments may be appropriately combined with one another.

The above-described embodiments have been described mainly for LTE systems (i.e., PS-LTE systems) that provide one or more public safety-related services (e.g., group communication service). However, these embodiments may be applied to public safety systems that use cellular communication networks other than LTE.

Furthermore, the above-described embodiment may be applied to a public safety system using a plurality of cellular communication networks of the same type or different types. In one example, one of the cellular communication networks may be a private cellular communication network and another one may be a public cellular communication network. Further or instead, one of the cellular communication networks may be an LTE network and another one may be a non-LTE cellular communication network.

The above-described embodiments are merely examples of applications of the technical ideas obtained by the inventor. These technical ideas are not limited to the above-described embodiments and various modifications can be made thereto.

This application is based upon and claims the benefit of priority from Japanese Patent Application No. 2019-055093, filed on Mar. 22, 2019, the disclosure of which is incorporated herein in its entirety by reference.

### REFERENCE SIGNS LIST

1 Network Platform
2 UE
3 LTE Network
11 PS Server
12 PS User Database
13 SIP Core
14 SIP Database
31 EPC
32 E-UTRAN
702 Processor
703 Memory
803 Baseband Processor
804 Application Processor
806 Memory

What is claimed is:

1. A system comprising:
at least one server configured to:
receive from an application running on a first wireless terminal, via a first communication path provided by a cellular communication network, a request for a communication session between the first wireless terminal and a second wireless terminal;
determine, based on one or both of a first priority associated with the first wireless terminal and a second priority associated with the second wireless terminal, a common priority to be applied to both a second communication path of the first wireless terminal and a third communication path of the second wireless terminal used for the communication session;
request the cellular communication network to establish the second and third communication paths that satisfy the common priority; and
provide the communication session to the first and second wireless terminals via the second and third communication paths.

2. The system according to claim 1, wherein the at least one server is configured to determine the common priority according to the higher one of the first priority and the second priority.

3. The system according to claim 1, wherein the at least one server is configured to determine the common priority according to the first priority.

4. The system according to claim 1, wherein the at least one server is configured to determine the common priority according to the second priority.

5. The system according to claim 1, wherein the first and second priorities relate to an application that utilizes the communication session.

6. The system according to claim 1, wherein
the at least one server comprises a first server and a second server,
the first server is configured to receive the request for the communication session from the first wireless terminal and request the second server to establish the communication session, and
the second server is configured to, in response to the request from the first server, check the first and second priorities, determine the common priority, and request the cellular communication network to establish the second and third communication paths that satisfy the common priority.

7. The system according to claim 6, wherein
the communication session is a push-to-talk (PTT) session between the first and second wireless terminals or a group communication session between a plurality of wireless terminals including the first and second wireless terminals,
the first server is a PTT server or a Group Communication System Application Server (GCS AS), and
the second server is a Session Initiation Protocol (SIP) server.

8. The system according to claim 1, wherein
the first communication path is an Evolved Packet System (EPS) bearer used to transfer signaling messages between the first wireless terminal and the system,
the second communication path is an EPS bearer used to transfer data packets regarding the communication session between the first wireless terminal and the system, and
the third communication path is an EPS bearer used to transfer data packets regarding the communication session between the second wireless terminal and the system.

9. A method performed by a system comprising at least one server, the method comprising:
receiving from an application running on a first wireless terminal, via a first communication path provided by a cellular communication network, a request for a communication session between the first wireless terminal and a second wireless terminal;
determining, based on one or both of a first priority associated with the first wireless terminal and a second priority associated with the second wireless terminal, a common priority to be applied to both a second communication path of the first wireless terminal and a third communication path of the second wireless terminal used for the communication session;
requesting the cellular communication network to establish the second and third communication paths that satisfy the common priority; and
providing the communication session to the first and second wireless terminals via the second and third communication paths.

10. The method according to claim 9, said determining includes determining the common priority according to the higher one of the first priority and the second priority.

11. The method according to claim 9, said determining includes determining the common priority according to the first priority.

12. The method according to claim 9, said determining includes determining the common priority according to the second priority.

13. The method according to claim 9, wherein the first and second priorities relate to an application that utilizes the communication session.

14. The system according to claim 9, wherein
the first communication path is an Evolved Packet System (EPS) bearer used to transfer signaling messages between the first wireless terminal and the system,
the second communication path is an EPS bearer used to transfer data packets regarding the communication session between the first wireless terminal and the system, and
the third communication path is an EPS bearer used to transfer data packets regarding the communication session between the second wireless terminal and the system.

15. A non-transitory computer readable medium storing one or more programs comprising computer readable instructions that, when loaded into one or more computers, cause the one or more computers to perform the method according to claim 9.
